(19) United States
(12) Patent Application Publication
(10) Pub. No.: US 2004/0034562 A1
(43) Pub. Date: Feb. 19, 2004

(54) Time service management apparatus, method, medium, and program

(75) Inventor: Hiroyuki Shuto, Nittagun (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/357,506

(22) Filed: Feb. 4, 2003

(30) Foreign Application Priority Data
Aug. 14, 2002 (JP) 2002-236556

(51) Int. Cl. G06F 17/60

(52) U.S. Cl. 705/14; 705/26

(57) ABSTRACT

The number of times of visit to shop in each time zone is collected for each customer, a time service can be set individually for each customer to the time zones in which the relevant customer visited the shop in the past. Moreover the time service is set for each customer by avoiding the crowded time zone by identifying the time zones of the shop as a whole in which the crowded condition is concentrated.

### CROSS-REFERENCE TO RELATED APPLICATIONS

This application claims the benefit of priority to Japanese Patent Application No. 2002-236556, filed Aug. 14, 2002 in Japan, the contents of which are incorporated herein by reference.

### BACKGROUND OF THE INVENTION

1. Field of the Invention

The present invention relates to a point-of-sale (POS) system comprising a shop server provided for management of transaction information to customers and management of time service to customers, and to a point-of-sale (POS) terminal providing for the transaction process of customers.

2. Description of the Related Art

Time service is one of shop services which are generally offered to customers from retail shops such as supermarkets. This time service is equally offered to customers in which particular items are set as the objects for reduction in price and discount within a limited time zone. Such a time zone is often designated in the evening. Moreover, in retail shops such as supermarkets, the shop is most crowded in the time zone beginning about three o'clock and ending about five o'clock in the evening. This time zone is the period before housewives, who are the main and principal customers of the shops, start preparation for dinner in a conventional life-style. In addition, the time service itself which has been designated to occur in this time zone is considered to be reason to accelerate the crowding condition of the shop.

This results in problems to be solved. As explained above, the existing time service has often been set in the evening, but certain customers cannot visit the shop to receive the time services set in this time zone. Therefore, such time service can be offered only to the limited customers who are utilizing the relevant shop, resulting in the problem that the other customers cannot receive the time service.

On the other hand, since the number of customers in a supermarket is rather small during time zones occurring in the morning, the total number of customers per day usually fluctuates. Therefore, there is a problem in that the total amount of work is rather small in the morning, but the number of members of shop staff is too short for the amount of work at the usually-crowded time zones in the evening. When the number of staff members becomes short at the crowded time zones, the possibility of shoplifting, for example, becomes high or services to customers will be degraded. In addition, when the shop is crowded, various bad effects are fallen on the customers who have visited the shop. For example, the customers will be required to stand in a waiting line for the adjustment of shopping and smooth movement in the shop is degraded.

### SUMMARY OF THE INVENTION

It is therefore an aspect of the present invention to provide a time service management apparatus, method, medium, and program which enables customers to receive time service at the time zone in which they can visit the shop and eliminates the crowded condition in the particular time zone by balancing the distribution of customers who have visited the shop during a day.

The above-mentioned aspects can be attained by a system of the present invention includes a structure comprising a shop visit collecting part collecting number of times of visits to a shop in each time zone of customers, and a customer time service setting part setting the time zones including the shop visit time zones in the past of the customers as the individual time zones for the time service of the customers based on the number of times of shop visit in each time zone collected for the customers.

Moreover, the present invention also comprises a transaction management part managing transactions of customers in the shop, a shop visit collecting part collecting a number of times of visits to the shop in each time zone for the customers, a crowded time zone identifying part identifying the crowded time zone of the shop in a day based on the number of times of visit to the shop collected for the customers, and a customer time service setting part setting individual time zones for time service for the customers based on the number of times of visits to the shop in each time zone collected for the customers and the identified crowded time zones.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a structural diagram of the system in the embodiment of the present invention.

FIG. 2 is a structural diagram of a shop service in the embodiment of the present invention.

FIG. 3 is a structural diagram of a point-of-sale (POS) terminal in the embodiment of the present invention.

FIG. 4 is a customer master (before setting of time service) in the embodiment of the present invention.

FIG. 5 is a customer master (after setting of time service) in the embodiment of the present invention.

FIG. 6 is an item master in the embodiment of the present invention.

FIG. 7 is a service type master in the embodiment of the present invention.

FIG. 8 is a shop visit record log table in the embodiment of the present invention.

FIG. 9 is a shop visit record log graph in the embodiment of the present invention.

FIG. 10 is a shop visit number collecting flow in each time zone in the embodiment of the present invention.

FIG. 11 is a transaction log file in the embodiment of the present invention.

FIG. 12 is a customer time service setting flow in the embodiment of the present invention.

FIG. 13 is a time service information notified to the customers in the embodiment of the present invention.

### DETAILED DESCRIPTION OF THE PREFERRED EMBODIMENTS

The embodiments of the present invention will be explained with reference to the accompanying drawings.

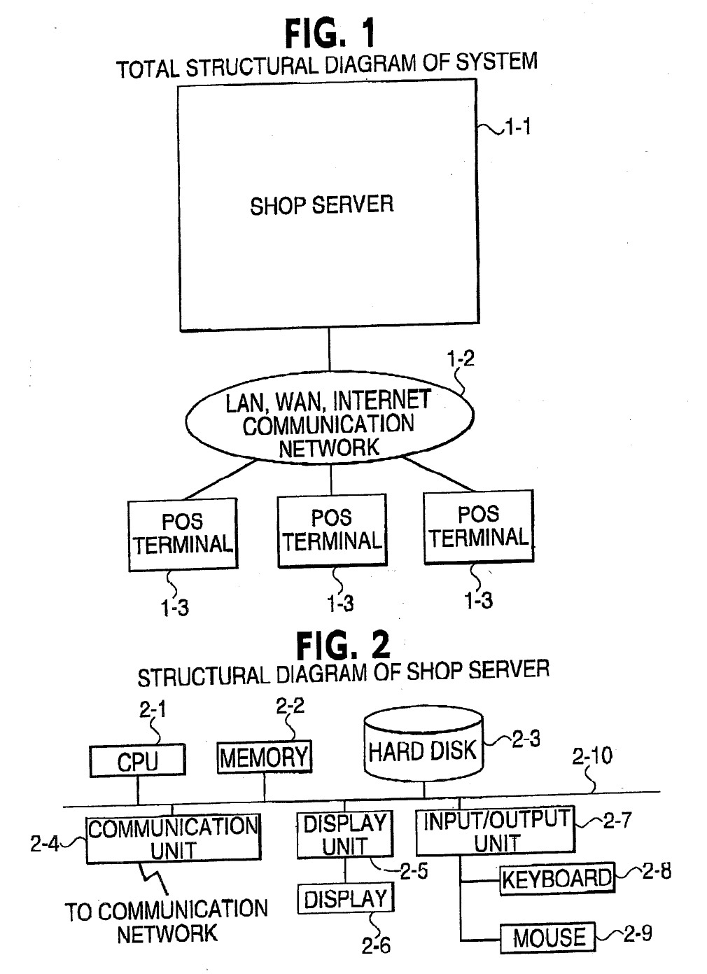

FIG. 1 illustrates a structural diagram of the system of the present invention. In this embodiment, there is provided a system structure in which a point-of-sale (POS) terminal (1-3) is connected to a shop server (1-1) via a communication means (1-2) such as a local area network (LAN), a wide area network (WAN), and the Internet or the like.

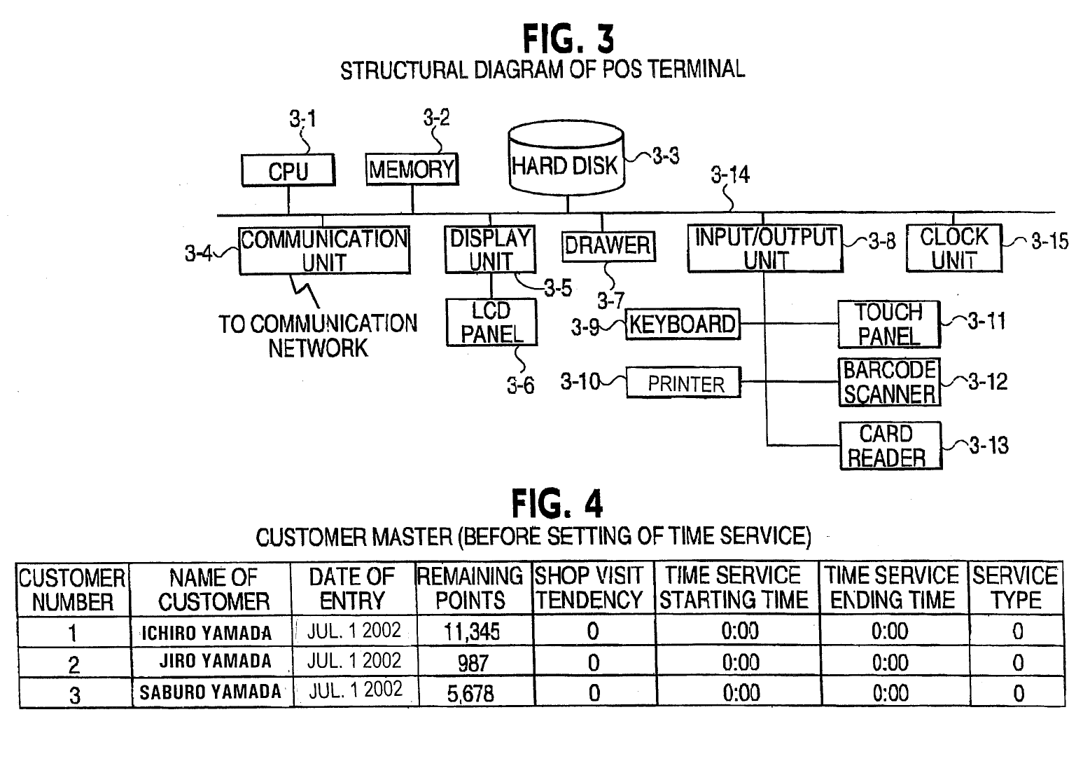

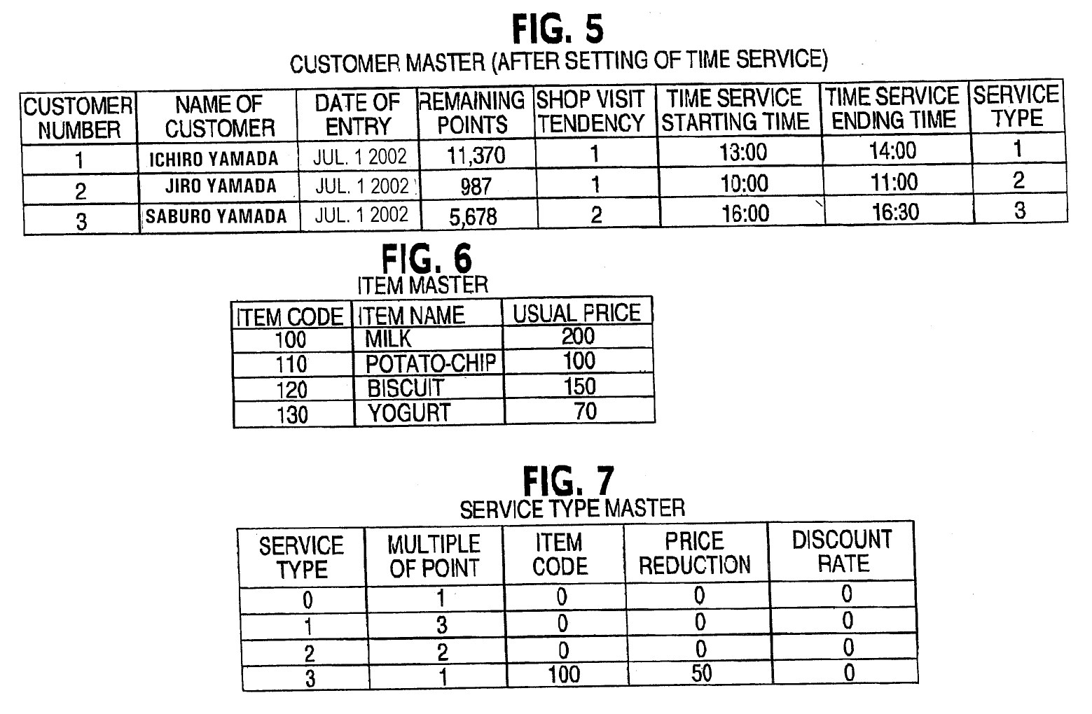

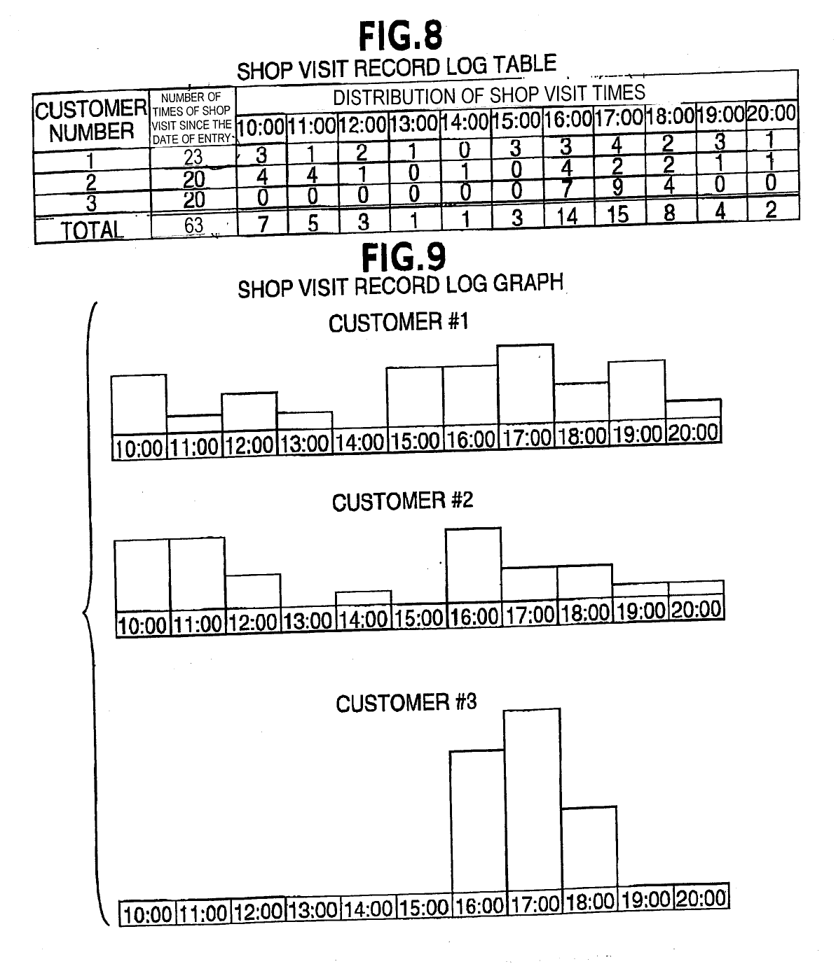

FIG. 2 is a block structure diagram of the shop server (2-1). The shop server comprises a CPU (2-1), a memory (2-2), a hard disk (2-3), a communication unit (2-4) for communicating with a communication network, a display unit (2-5), a display (2-6), an input/output control unit (2-7), a keyboard (2-8), a mouse (2-9) and a bus (2-10). The hard disk (2-3) stores, as programs, a transaction management part, a shop visit collecting part, a crowded time zone identifying part, a customer shop visit tendency identifying part, a customer time service setting part, and a time service information notifying part. These programs are loaded to the memory (2-2), read from the CPU (2-1) and are then sequentially executed. A database comprises a customer master illustrated in FIG. 4 and FIG. 5, an item master illustrated in FIG. 6, a service type master illustrated in FIG. 7 and shop visit record log table illustrated in FIG. 8 is stored in the hard disk (2-3).

FIG. 3 is a block structural diagram of a POS terminal (1-4). The POS terminal comprises a CPU (3-1), a memory (3-2), a hard disk (3-3), a communication unit for making communication with a communication network, a display unit (3-5), an LCD panel (3-6), a drawer (3-7), an input/output unit (3-8), a keyboard (3-9), a printer (3-10), a touch panel (3-11), a barcode scanner (3-12), a card reader (3-13), a bus (3-14) for connecting these units and a clock unit (3-15).

Next, FIG. 4 to FIG. 9 will be explained. These files are closely related with each other and are the essential portions of the present invention.

FIG. 4 illustrates the customer master before setting of the time service, respectively storing customer names, date of entry, remaining points, shop visit tendency type, time service starting time, time service ending time and type of service for three customers of No. 1 to No. 3. The date of entry is set, in this embodiment, to Jul. 1, 2002 for the three customers for the convenience of explanation. In this shop, a point is given to each customer for the amount of transaction, for example, in terms of ¥10=1(one) point and the present remaining points of each customer are stored as the remaining point. The shop visit tendency type indicates the tendency of shop visit of a customer in a day which may be extracted from distribution of shop visit time of a customer in a day. In this embodiment, the customer 1 shows the shop visit tendency in which distribution of shop visit time is dispersed, while the customer 2 shows the shop visit tendency in which distribution of shop visit time is concentrated to the particular time zone. The type of service indicates a type of service offered to each customer during the period from the time service starting time to the time service ending time. Meaning of each numerical character is stored in the service type master of FIG. 7. The customer master of FIG. 4 is generated before setting of the time service. Therefore, the data “0” is set for the shop visit tendency type, time service starting time, time service ending time and service type, indicating that the time service is not yet set for all customers. Setting of time service will be explained later but the customer master for the condition after the setting is illustrated in FIG. 5.

The service type master of FIG. 7 illustrates a multiple, an item code, a reduction amount of price and a discount rate for each service type. The services to be offered by the time service include two kinds of service. One is a multiple of point. Namely, the points obtained by multiplying the point usually given with a multiple are given. The other is reduction of price or discount for the particular items. In this embodiment, the service type=0 means that a multiple of point=1, item code, price reduction and discount rate are all 0, namely the particular service is not offered, while the service type 1 means that a multiple of point=3, item code, price reduction and discount rate are all 0, namely only the points equal to three times of usual point are given, the service type 2 means that a multiple of point=2, item code, price reduction and discount rate are all 0, namely only the points equal to two times of usual point are given and the service type 3 means that a multiple of point=1, item code=100, price reduction=¥50, discount rate=0%, namely ¥50 is reduced from the usual price of item for the item having the item code 100. The item code and item are close related in the item master of FIG. 6 and it can be understood by referring to FIG. 6 that the item having the item code 100 is the item name=Milk having the usual price=¥200.

Moreover, the shop visit record log table of FIG. 8 indicates the number of times of shop visit since the date of entry and distribution of shop visit times of each customer. In this embodiment, distribution during the period from the shop opening time 10:00 to the shop closing time 21:00 is indicated. For example, “10:00” indicates the number of times of shop visit at the time after 10:00 and before 11:00. The time service to be offered to each customer through analysis of this distribution will be explained later.

The shop visit record log graph of FIG. 9 visually illustrates the distribution of times indicated in the shop visit record log table of FIG. 8. This illustration is intrinsically provided for understanding of this embodiment and it not the essential portion for embodiment of the present invention.

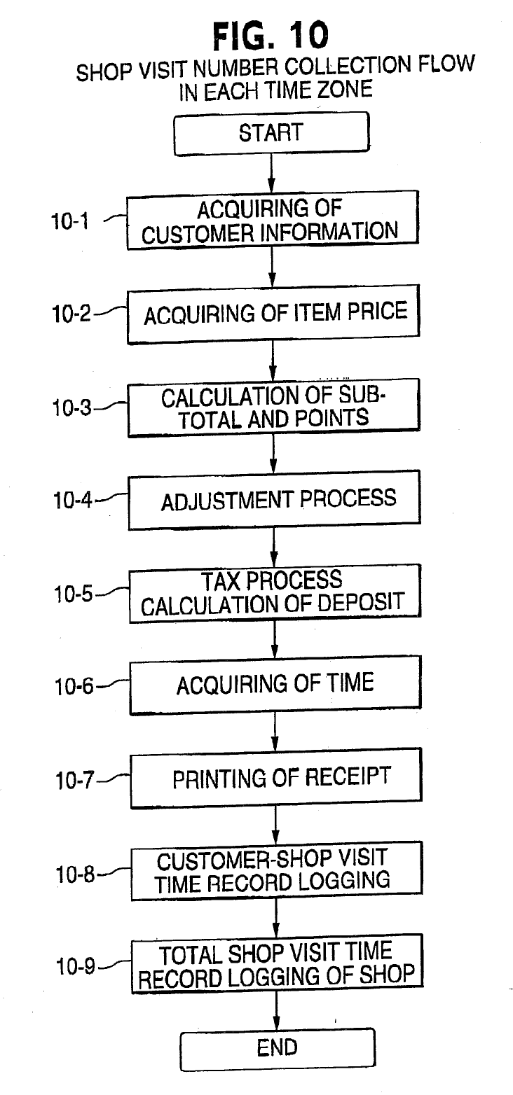

Next, an example of a shop visit number collection flow in each time zone of FIG. 10 will be explained for the customer No. 1 (for example, Mr. Yamada).

First, Mr. Yamada presents his own customer card to a shop staff at the time of starting a transaction at the POS terminal. The shop staff reads information stored in the relevant card using the card reader (3-13) connected to the POS terminal and acquires (7-1) the detail of the present customer information of Mr. Yamada based on such information on the memory (3-2) of the POS terminal from the customer master (FIG. 4) of the shop server. According to the customer master of FIG. 4, it can be detected that the present remaining points of Mr. Yamada (A) are 11,345 points and any time service is not yet set to him because the shop visit tendency type, time service starting time, time service ending time and service type are all 0.

Next, when it is assumed that Mr. Yamada has selected, in this shopping, a potato-chip having the item code 110 and a biscuit having the item code 120, the shop staff reads the item codes of the relevant items with the manipulation such as reading of barcode with the barcode scanner (3-12) and acquires (7-2) the usual prices of potato chip (¥100) and biscuit (¥150) by looking up the relevant item codes to the item master of shop server. Thereafter, the shop staff detects the sub-total of this transaction is ¥250 by depressing a sub-total key (not illustrated) on the POS terminal. Here, the 25 points are added to the remaining points (11,345 points) of Mr. Yamada and the remaining points of Mr. Yamada on the customer master is updated to 11,370 points with the transaction management part of the shop server (in this embodiment, it is fixedly set on the program that ¥10 is converted to 1 point at the time of obtaining the point) (7-3). Thereafter, the payment is executed through the adjustment process (7-4) and tax/deposit calculation (7-5). Thereby, the transaction end time is obtained (7-6) from the clock unit (3-15) of the POS terminal and a receipt (not illustrated) on which contents of this transaction and transaction end time are printed is outputted from the printer (3-10) of the POS terminal (7-7) to totally complete this transaction.

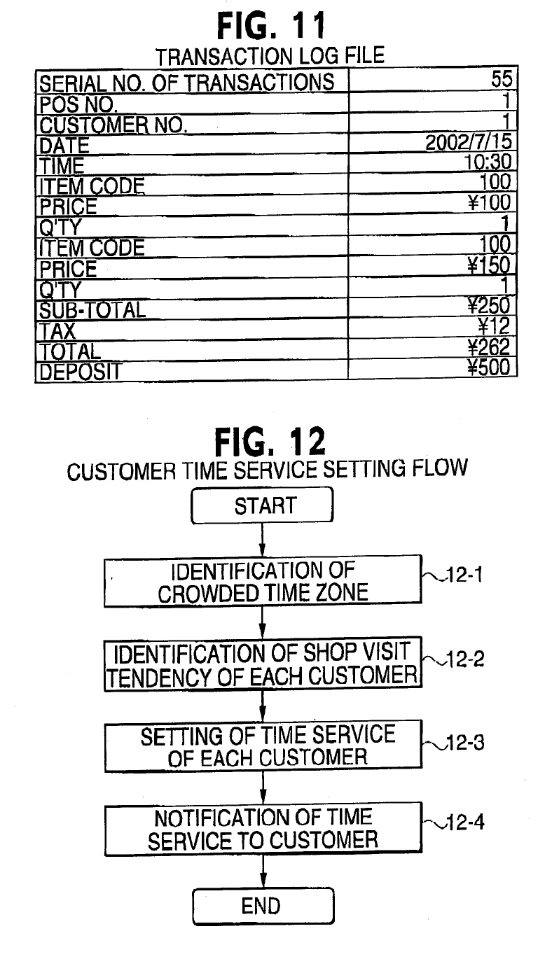

When the transaction is completed, the CPU (2-1) of shop server executes the transaction management part on the memory (2-1) to store the relevant transaction data to the transaction log file illustrated in FIG. 11 being stored in the hard disk (2-3) of the shop server.

According to the transaction log file, since this transaction is executed at 10:30, the shop visit number of the customer No. 1 in the shop visit record log table of FIG. 8 is incremented by one (+1) with the shop visit number collecting part in each time zone of the shop server and the shop visit number of the shop visit time 10:00 is also incremented by one (+1). FIG. 8 illustrates an example where the shop visit number of the customer No. 1 is updated to 23 and the shop visit number of the time 10:00 is updated to 3. Moreover, similarly, the total number of times of shop visit in the shop is also incremented by one (+1) with the shop visit collecting part and thereby updated to 63 and moreover the shop visit number of time 10:00 is also incremented by one (+1) and updated to 7 (7-9).

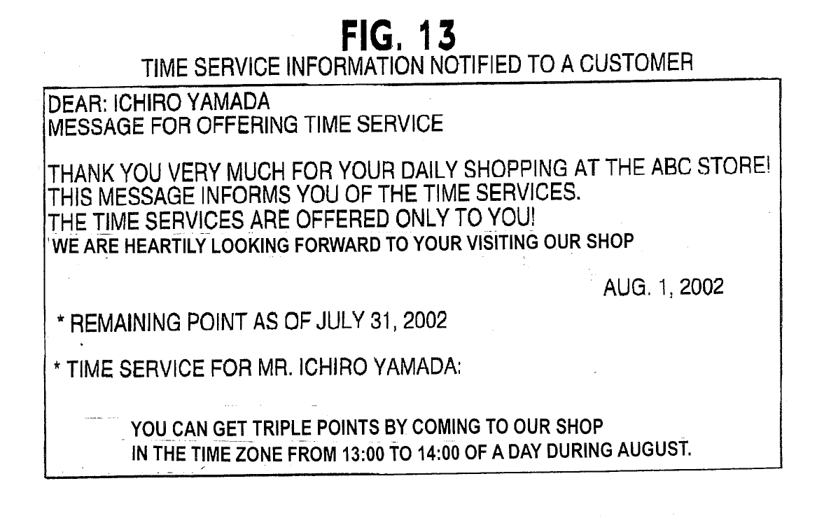

Thereafter, the shop visit tendency of the customers after one month from the entry is identified, for example, with the shop closing process or the like and the time service is respectively set for each customer. The flow of such processes will then be explained with reference to FIG. 12.

First, the crowded time zone of the relevant shop is identified with the crowded time zone identifying part of the shop server. According to the shop visit record log table of FIG. 8, the total distribution of shop visit number in each time zone indicates 14 shop visits in the time 16:00 and 15 shop visits in the time 17:00 and thereby it can be identified that the crowded condition is concentrated to the period from 16:00 to 18:00 and the shop is rather empty during the period from 13:00 to 15:00 (12-1).

Next, the customer shop visit tendency identifying part of the shop server identifies the shop visit tendency of each customer. In the embodiment, today is assumed as Aug. 1, 2002, since the date of entry of the customers No. 1 to No. 3 is Jul. 1, 2002, the shop visit tendency of the relevant three customers can be identified. According to the shop visit record log table of FIG. 8, the shop visit number distribution of the customer No. 1 shows the shop visit tendency of “shop visit time distribution is dispersed” as explained above, namely the shop visit number tendency of the customer No. 1 can be classified to the type 1. Therefore, “1” is stored to the shop visit tendency of the customer No. 1 of the customer master (after setting of time service) of FIG. 5. In the same manner, “1” is also stored to the shop visit tendency type of the customer No. 2 of the customer master (after setting of time service) of FIG. 5 for the customer No. 1. Meanwhile, since the shop visit of the customer No. 3 is concentrated to the times of 16:00, 17:00 and 18:00 and the customer No. 3 almost does not visit the shop at the other periods, the shop visit tendency of the customer No. 3 shows the tendency “shop visit time distribution is concentrated to the particular time zones” as explained above, namely the shop visit tendency of the customer No. 3 is classified to the type “2” and therefore the type “2” is set to the shop visit tendency type of the customer No. 3 of the customer master (after setting of time service) of FIG. 5 (12-2).

Next, the customer time service setting part of the shop server sets the time service to the time zone, except for the period from 16:00 to 18:00 identified by the crowded time zone identifying part, in which each customer has visited the shop. According to the shop visit record log table of FIG. 8, in the case of customer No. 1, since the shop visit tendency type is 1 and shop visit at the time of 13:00 where the shop is rather empty is recorded, the time service of the customer No. 1 is set to the period from 13:00 to 14:00. The service type is not particularly specified here and is determined depending on the operation of shop. In this embodiment, “1” is set to the service type. Therefore, in the customer master of FIG. 5(after setting of time service), the time service starting time=13:00 of the customer No. 1, time service ending time=14:00 and service type=1 are stored. With the similar method, for the customer No. 2, the time service starting time=14:00, time service ending time=15:00 and service type=2 are stored to the customer master of FIG. 5 (after setting of time service). On the other hand, the customer No. 3 is classified to the shop visit tendency type=2 and the shop visit time of this customer No. 3 is concentrated to the period of 16:00 to 18:00 just corresponding to the crowded time zone of shop. However, from the total viewpoint of shop, since the shop visit number in the time of 18:00 is rather small in comparison with the period from 16:00 to 18:00 and the customer No. 3 has also visited the shop in the time of 18:00, the time service of the customer No. 3 is set tot the period from 18:00 to 19:00. Therefore, the time service starting time=18:00, time service ending time=19:00 and service type=3 are stored in the customer master of FIG. 5 (after setting of time service) (12-3).

Finally, the time service information notifying part of shop server notifies the time services set as explained above to each customer (12-4). FIG. 13 illustrates an example of notification (message) to the customer No. 1. As the time service information notifying means, various methods such as direct mail, e-mail, display on the member card and printing on the receipt, etc.

Moreover, in this embodiment, a way of determining the contents of services to be offered to the customers as the time service is not yet determined but it is also possible as the method to determine the contents of time service, for example, to give a rank depending on the number of times of shop visit and amount of purchase of customers in the past.

The present invention provides the effect that distribution in the number of customers of the shop in a day can be balanced to alleviate the crowded condition in the particular time zones. Moreover, the customers of the shop are capable of enjoying the time services in the favorite time zones. As a result, the shop visiting frequency of customers may further be enhanced.

The present invention solves the problem that the customers cannot enjoy the time services sufficiently because the time services in a retail shop such as a super-market are usually set to the particular time zones in the evening or the like and thereby the shop is very crowded at the time zones concentrated to the evening.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A time service management apparatus offering time services to customers visiting the shop, comprising:
shop visit collecting means for collecting number of times of visit to shop in each time zone by said each customer; and
customer time service setting means for setting the time zones including the past shop visit time zones of said each customer as the individual time zones for the time service of said each customer based on the number of times of shop visit in each time zone collected for said each customer.

2. A time service management apparatus according to claim 1, further comprising a time service information notifying means for notifying, to said each customer, time service information including the time zone for the time service preset by said customer time service setting means.

3. A time service management apparatus, comprising:
transaction management means for management of transactions of customers in the shop;
shop visit collecting means for collecting number of times of visit to shop in each time zone by said each customer;
crowded time zone identifying means for identifying the crowded time zone of said shop in a day based on the number of times of visit to shop collected for said customers; and
customer time service setting means for setting individual time zone for the time service for said each customer based on said number of times of visit to shop in each time zone collected for said each customer and said identified crowded time zones.

4. A time service management apparatus according to claim 3, wherein said customer time service setting means sets the time zone other than said crowded time zone including the past shop visit time zones of said each customer as the individual time zones for the time service for said each customer.

5. A time service management program stored on a computer-readable medium and functioning by operating a computer executing the program and connected to a terminal in a communication network, said program comprising:
shop visit collecting means for collecting number of times of visit to shop in each time zone by said each customer; and
customer time service setting means for setting the time zones including the past shop visit time zones as the individual time zones for the time service of said each customer based on the number of times of shop visit in each time zone collected for said each customer.

6. A time service management apparatus according to claim 2, wherein the time service information includes any one of the item price reduction service, item discount service and service to give the points to the customers.

7. A time service management apparatus according to claim 3 further comprising a time service information notifying means for notifying to each customer the time service information including the time zone for time service set by the customer time service setting means.

8. A time service management apparatus according to claim 7 wherein the time service information includes any one of the item price reduction service, item discount service and service to give the points to the customers.

9. A time service management system offering a time service to customers in a shop comprising:
a time service management apparatus comprising:
at least a terminal connected to a communication network;
shop visit number collecting means for collecting the number of times of shop visit in each time zone for the customers, and
customer time service setting means for setting the time zone including the time zone in which customers visited the shop in the past as the time zone for individual time services for the customers.

10. A time service management system according to claim 9 further comprising a time service information notifying means for notifying, for each customer, the time service information including the time zone for time service preset by the customer time service setting means.

11. A time service management system according to claim 10 wherein the time service information includes any one of the item price reduction service, item discount service and service to give the points to the customers.

12. A time service management system comprising:
a time service management apparatus comprising:
at least a terminal connected to a communication network,
shop visit number collecting means for collecting the number of times of visit to the shop in each time zone for the customers,
crowded time zone identifying means for identifying the crowded time zone of the shop as a whole in a day based on the number of times of shop visits in each time zone collected for each customer, and
customer time service setting means for setting the time zone for individual time services for the customers based on the number of times of shop visits collected for the customers and the identified crowded time zone.

13. A time service management system according to claim 12 wherein the customer time service setting means sets the time zone other than the crowded time zone including the time zones in which the customers visited the shop in the past as the individual time zones for time services of the customers.

14. A time service management system according to claim 12 further comprising a time service information notifying means for notifying, to each customer, the time service information including the time zone for time service preset by the customer time service setting means.

15. A time service management system according to claim 14 wherein the time service information includes any one of the item price reduction service, item discount service and service to give the points to the customers.

16. A time service management program according to claim 5 further comprising a time service information notifying means for notifying the time service information including the time zones for time service preset by the customer time service setting means to the customers.

17. A time service management program according to claim 16 wherein the time service information includes any one of the item price reduction service, item discount service and service to give the points to the customers.

18. A time service management program stored on a computer-readable medium and functioning by operating the computer executing the program and connected to a terminal through a communication network, said program comprising:
transaction management means for management of transactions of the customers in the shop,
shop visit number collecting means for collecting the number of times of visit to shop in each time zone for the customers,
crowded time zone identifying means for identifying the crowded time zones of the shop as a whole in a day based on the number of times of visit to shop in each time zone collected for the customers, and
customer time service setting means for setting individual time zones for time service for the customers based on the number of times of visit to ship in each time zone collected for the customers and the identified crowded time zones.

19. A time service management program according to claim 18 wherein the customer time service setting means sets the time zones other than the crowded time zones including the time zones in which the customer visited the shop in the past as the individual time zones for time service for the customers.

20. A time service management program according to claim 18 further comprising a time service information notifying means for notifying the time service information including the times zone for time service preset by the customer time service setting means.

21. A time service management program according to claim 20 wherein the time service information includes any one of the item price reduction service, item discount service and service to give the points to the customers.

22. A time service management method offering time service to customers in a shop comprising:
collecting the number of times of shop visit in each time zone for the customers, and
setting the time zones including the time zones in which the customers visited the shop in the past as the individual time zones for time service for the customers based on the number of times of visit to shop in each time zone collected for the customers.

23. A time service management method according to claim 22 wherein the time service information including the preset individual time zones for time service for the customers is notified to the customers.

24. A time service management method according to claim 23 wherein the timer service information includes any one of the item price reduction service, item discount service and service to give the points to the customers.

25. A time service management method comprising:
conducting the management of transactions of the customers in the shop,
collecting the number of times of visit to shop in each time zone for the customers,
identifying the crowded time zones of the shop as a whole in a day based on the number of times of visit to shop in each time zone collected for the customers, and
setting individual time zones for time service for the customers based on the number of times of visit to shop in each time zone collected for the customers and the identified crowded time zones.

26. A time service management method according to claim 25 wherein the individual time zones for time service for the customers is the time zones other than the crowded time zones including the time zones in which the customers visited the shop in the past.

27. A time service management method according to claim 25 wherein the time service information including the preset individual time zones for time service for the customers is notified to the customers.

28. A time service management method according to claim 27 wherein the time service information includes any one of the item price reduction service, item discount service and service to give the points to the customers.

29. A time service management apparatus comprising:
transaction management means for management of transactions of the customers in the shop,
shop visit number collecting means for collecting the number of times of visit to shop in each time zone for the customers,
crowded time zone identifying means for identifying the crowded time zones of the shop as a whole in a day based on the number of times of visit to shop in each time zone collected for the customers,
customer shop visit tendency identifying means for identifying the customers to have the tendency in which the shop visit distribution is concentrated to the particular time zones or the tendency in which the shop visit distribution is dispersed in various time zones in a day by analyzing the distribution of shop visit time in a day of the customers based on the number of times of visit to shop in each time zone collected for the customers,
customer time service setting means for setting, to the customers having the tendency in which the shop visit time distribution is concentrated to the particular time zones, the time zones including the relevant particular time zones as the time zones for time service for the relevant customers and also setting, to the customers having the tendency in which shop visit time distribution is dispersed to various times zones in a day, the time zones other than the crowded time zones including the times zones in which the customers visited the shop in the past as the time zones for the time service for the relevant customers, and
time service information notifying means for notifying, to the customers, the time service information including the time zones for the time service preset by the customer time service setting means.

30. A time service management apparatus according to claim 29 wherein the time service information includes any one of the item price reduction service, item discount service and service to give the points to the customers.

31. A time service management apparatus according to claim 4 further comprising a time service information notifying means for notifying to each customer the time service information including the time zone for time service set by the customer time service setting means.

32. A time service management system according to claim 13 further comprising a time service information notifying means for notifying, to each customer, the time service information including the time zone for time service preset by the customer time service setting means.

33. A time service management program according to claim 19 further comprising a time service information notifying means for notifying the time service information including the times zone for time service preset by the customer time service setting means.

34. A time service management method according to claim 26 wherein the time service information including the preset individual time zones for time service for the customers is notified to the customers.

35. A time service management apparatus offering time services to customers visiting the shop, comprising:
a shop visit collecting part collecting number of times of visits to a shop in each time zone by each customer; and
a customer time service setting part setting the time zones including the past shop visit time zones of said each customer as the individual time zones for the time service of said each customer based on the number of times of shop visits in each time zone collected for said each customer.

36. A time service management apparatus according to claim 35, further comprising a time service information notifying part notifying, to said each customer, time service information including the time zone for the time service preset by said customer time service setting part.

37. A time service management apparatus, comprising:
a transaction management part managing transactions of customers in a shop;
a shop visit collecting part collecting a number of times of visits to the shop in each time zone by said each customer;
a crowded time zone identifying part identifying the crowded time zone of said shop in a day based on the number of times of visits to the shop collected for said customers; and
a customer time service setting part setting individual time zones for the time service for said each customer based on said number of times of visits to the shop in each time zone collected for said each customer and said identified crowded time zones.

38. A time service management apparatus according to claim 37, wherein said customer time service setting part sets the time zone other than said crowded time zone including the past shop visit time zones of said each customer as the individual time zones for the time service for said each customer.

39. A time service management apparatus according to claim 36, wherein the time service information includes any one of the item price reduction service, item discount service and service to give the points to the customers.

40. A time service management apparatus according to claim 37 further comprising a time service information notifying part notifying to each customer the time service information including the time zone for time service set by the customer time service setting part.

41. A time service management apparatus according to claim 40 wherein the time service information includes any one of the item price reduction service, item discount service and service to give the points to the customers.

42. A time service management system offering a time service to customers in a shop comprising:
a time service management apparatus comprising:
at least a terminal connected to a communication network;
a shop visit number collecting part collecting the number of times of shop visits in each time zone for the customers, and
a customer time service setting part setting the time zone including the time zone in which the customers visited the shop in the past as the time zone for individual time services for the customers.

43. A time service management system according to claim 42 further comprising a time service information notifying part notifying, for each customer, the time service information including the time zone for time service preset by the customer time service setting part.

44. A time service management system according to claim 43 wherein the time service information includes any one of the item price reduction service, item discount service and service to give the points to the customers.

45. A time service management system comprising:
a time service management apparatus comprising:
at least a terminal connected to a communication network,
a shop visit number collecting part collecting the number of times of visits to the shop in each time zone for the customers,
a crowded time zone identifying part identifying the crowded time zone of the shop as a whole in a day based on the number of times of shop visits in each time zone collected for each customer, and
a customer time service setting part setting the time zone for individual time services for the customers based on the number of times of shop visits collected for the customers and the identified crowded time zone.

46. A time service management system according to claim 45 wherein the customer time service setting part sets the time zone other than the crowded time zone including the time zones in which the customers visited the shop in the past as the individual time zones for time services of the customers.

47. A time service management system according to claim 45 further comprising a time service information notifying part notifying, to each customer, the time service information including the time zone for time service preset by the customer time service setting part.

48. A time service management system according to claim 47 wherein the time service information includes any one of the item price reduction service, item discount service and service to give the points to the customers.

49. A time service management apparatus according to claim 38 further comprising a time service information notifying part notifying to each customer the time service information including the time zone for time service set by the customer time service setting part.

50. A time service management system according to claim 46 further comprising a time service information notifying part notifying, to each customer, the time service information including the time zone for time service preset by the customer time service setting part.

51. A time service management program product stored on a computer-readable medium and functioning by operating a computer executing the program product and connected to a terminal in a communication network, said program product comprising:
shop visit collecting means for collecting number of times of visit to shop in each time zone by said each customer; and
customer time service setting means for setting the time zones including the past shop visit time zones as the individual time zones for the time service of said each customer based on the number of times of shop visit in each time zone collected for said each customer.

52. A time service management program product according to claim 51 further comprising time service information notifying means for notifying the time service information including the time zones for time service preset by the customer time service setting means to the customers.

53. A time service management program product according to claim 52 wherein the time service information includes any one of the item price reduction service, item discount service and service to give the points to the customers.

54. A time service management program product stored on a computer-readable medium and functioning by operating the computer executing the program and connected to a terminal through a communication network, said program product comprising:
transaction management means for management of transactions of the customers in the shop,
shop visit number collecting means for collecting the number of times of visit to shop in each time zone for the customers,
crowded time zone identifying means for identifying the crowded time zones of the shop as a whole in a day based on the number of times of visit to shop in each time zone collected for the customers, and
customer time service setting means for setting individual time zones for time service for the customers based on the number of times of visit to ship in each time zone collected for the customers and the identified crowded time zones.

55. A time service management program product according to claim 54 wherein the customer time service setting means sets the time zones other than the crowded time zones including the time zones in which the customer visited the shop in the past as the individual time zones for time service for the customers.

56. A time service management program product according to claim 54 further comprising time service information notifying means for notifying the time service information including the times zone for time service preset by the customer time service setting means.

57. A time service management program product according to claim 56 wherein the time service information includes any one of the item price reduction service, item discount service and service to give the points to the customers.

58. A computer-readable medium storing a time service management program offering time service to customers in a shop which when executed by a computer causes the computer to execute the operations comprising:
collecting the number of times of shop visit in each time zone for the customers, and
setting the time zones including the time zones in which the customers visited the shop in the past as the individual time zones for time service for the customers based on the number of times of visit to shop in each time zone collected for the customers.

59. A computer-readable medium according to claim 58 wherein the time service information including the preset individual time zones for time service for the customers is notified to the customers.

60. A computer-readable medium according to claim 59 wherein the timer service information includes any one of the item price reduction service, item discount service and service to give the points to the customers.

61. A computer-readable medium storing a time service management program which when executed by a computer causes the computer to execute the operations comprising:
conducting the management of transactions of the customers in the shop,
collecting the number of times of visit to shop in each time zone for the customers,
identifying the crowded time zones of the shop as a whole in a day based on the number of times of visit to shop in each time zone collected for the customers, and
setting individual time zones for time service for the customers based on the number of times of visit to shop in each time zone collected for the customers and the identified crowded time zones.

62. A computer-readable medium according to claim 61 wherein the individual time zones for time service for the customers is the time zones other than the crowded time zones including the time zones in which the customers visited the shop in the past.

63. A computer-readable medium according to claim 61 wherein the time service information including the preset individual time zones for time service for the customers is notified to the customers.

64. A computer-readable medium according to claim 63 wherein the time service information includes any one of the item price reduction service, item discount service and service to give the points to the customers.
